(19) United States
(12) Patent Application Publication
(10) Pub. No.: US 2025/0269668 A1
(43) Pub. Date: Aug. 28, 2025

(54) RECORDING DEVICE

(71) Applicant: SEIKO EPSON CORPORATION, Tokyo (JP)

(72) Inventors: Satoshi NAKATA, MATSUMOTO-SHI (JP); Toru YOSHIZAWA, MATSUMOTO-SHI (JP); Katsumi YAMADA, MATSUMOTO-SHI (JP)

(21) Appl. No.: 19/061,044

(22) Filed: Feb. 24, 2025

(30) Foreign Application Priority Data
Feb. 26, 2024 (JP) 2024-026251

(51) Int. Cl. B41J 11/70; B41J 29/13

(52) U.S. Cl. CPC B41J 11/706; B41J 29/13

(57) ABSTRACT

A recording device includes a conveyance section configured to convey a medium in a conveyance direction along a conveyance path, a recording section configured to record an image on the medium conveyed by the conveyance section, a cutter unit including a cutter blade for cutting the medium in the conveyance path, a cutter carriage to which the cutter unit is detachably attachable, the cutter carriage moving in a width direction intersecting the conveyance direction, and a restriction section configured to restrict detachment of the cutter unit from the cutter carriage.

The present application is based on, and claims priority from JP Application Serial Number 2024-026251, filed Feb. 26, 2024, the disclosure of which is hereby incorporated by reference herein in its entirety.

### BACKGROUND

### 1. Technical Field

The present disclosure relates to a recording device.

### 2. Related Art

For example, JP-A-2023-132634 discloses that, in a recording device that performs recording on a medium conveyed along a conveyance path, the medium is cut by a cutter blade. In such a recording device, a cutter unit, in which the cutter blade is housed, is detachably attached to a cutter carriage movable in the width direction of the medium.

JP-A-2023-132634 is an example of the related art.

However, in such a recording device, when a user unintentionally detaches the cutter unit from the cutter carriage, the cutter unit is likely to come into contact with the cutter blade exposed from the cutter unit. Thus, it is desired to improve safety for the cutter blade.

### SUMMARY

According to an aspect of the present disclosure, there is provided a recording device including: a conveyance section configured to convey a medium in a conveyance direction along a conveyance path; a recording section configured to record an image on the medium conveyed by the conveyance section; a cutter unit including a cutter blade for cutting the medium in the conveyance path; a cutter carriage to which the cutter unit is detachably attachable, the cutter carriage moving in a width direction intersecting the conveyance direction; and a restriction section configured to restrict detachment of the cutter unit from the cutter carriage.

### BRIEF DESCRIPTION OF THE DRAWINGS

FIG. 1 is a perspective view illustrating a recording device in a first embodiment.

FIG. 2 is a perspective view illustrating a storage cassette in the first embodiment.

FIG. 3 is a perspective view illustrating a recording device in the first embodiment.

FIG. 4 is a diagram illustrating the recording device in the first embodiment.

FIG. 5 is a perspective view illustrating a cutting section in the first embodiment.

FIG. 6 is a perspective view illustrating the cutting section in the first embodiment.

FIG. 7 is a side view illustrating the cutting section in the first embodiment.

FIG. 8 is a perspective view illustrating the recording device in the first embodiment.

FIG. 9 is a perspective view illustrating the cutting section in the first embodiment.

FIG. 10 is a perspective view illustrating the cutting section in the first embodiment.

FIG. 11 is a flowchart illustrating replacement control processing in the first embodiment.

FIG. 12 is a perspective view illustrating a cutting section in a second embodiment.

FIG. 13 is a perspective view illustrating the cutting section in the second embodiment.

### DESCRIPTION OF EMBODIMENTS

### First Embodiment

A recording device according to an embodiment is explained below. In the following explanation, a direction intersecting the vertical direction Z is defined as a width direction X and a direction intersecting the vertical direction Z and the width direction X is defined as a front-rear direction Y. One side in the width direction X is defined as a first width direction X1 and the other side in the width direction X is defined as a second width direction X2. One side in the front-rear direction Y is defined as a front direction Y1 and the other side in the front-rear direction Y is defined as a rear direction Y2. An upward direction in the vertical direction z is defined as an upward direction Z1 and a downward direction in the vertical direction Z is defined as a downward direction Z2.

### Configuration of a Recording Device 10

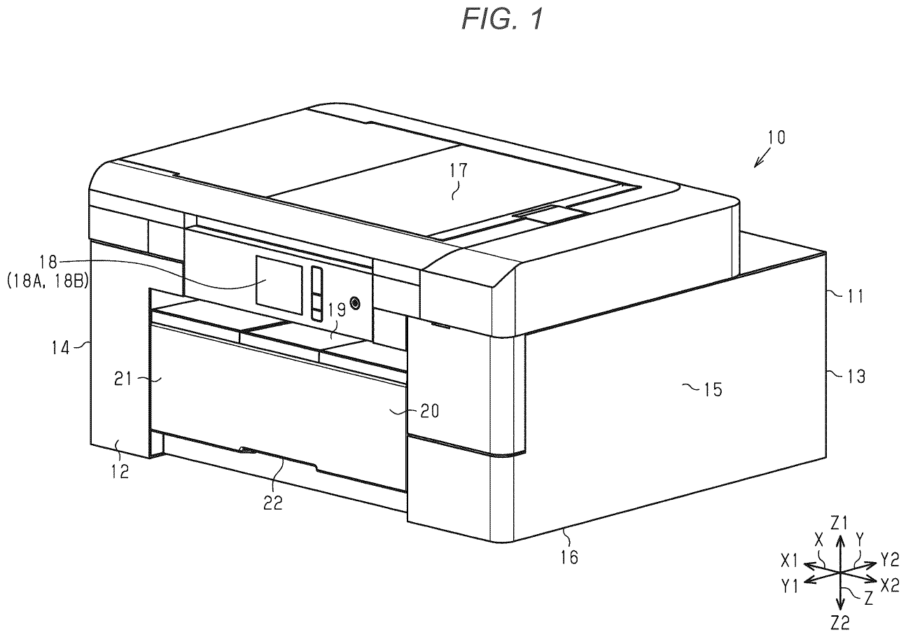

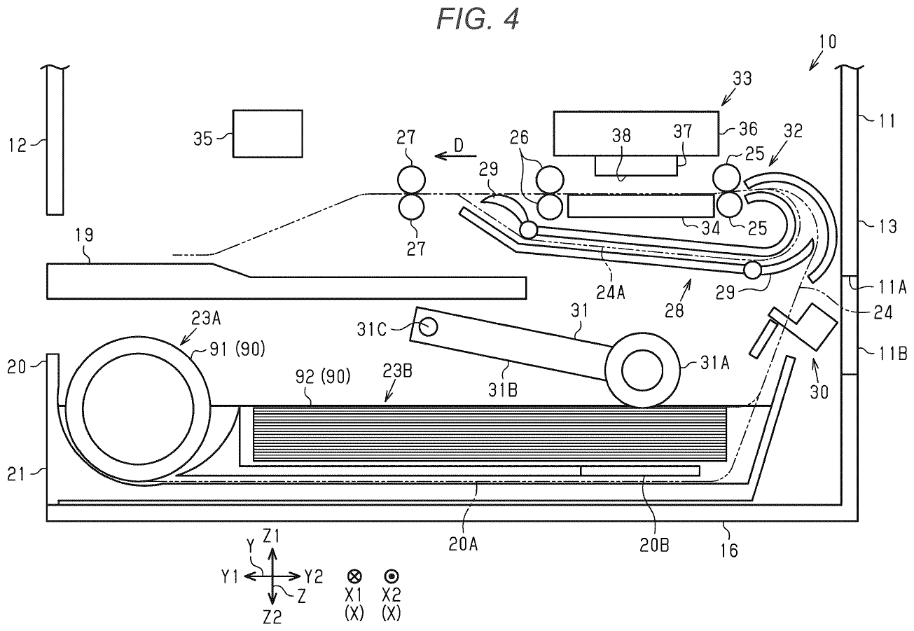

As illustrated in FIG. 1, a recording device 10 is a device that records an image on a medium 90 illustrated in FIG. 4. The recording device 10 may be a device that records an image on the medium 90 by ejecting liquid. The liquid may be, for example, ink. The liquid may have, for example, a plurality of kinds of colors or one kind of a color. The medium 90 may be, for example, roll paper 91 and paper 92 illustrated in FIG. 4. The roll paper 91 is a roll-shaped medium 90. The paper 92 is a sheet-shaped medium 90. The paper 92 is plain paper. The recording device 10 may be a device that can perform recording on a plurality of kinds of media 90.

The recording device 10 includes a housing 11. The housing 11 is an exterior of the recording device 10. The housing 11 configures a front surface 12, a rear surface 13, a left side surface 14, a right side surface 15, a bottom surface 16, and a top surface 17 of the recording device 10 but is not limited to this. The housing 11 may configure at least a part of the front surface 12, a part of the rear surface 13, a part of the left side surface 14, a part of the right side surface 15, a part of the bottom surface 16, and a part of the top surface 17 of the recording device 10. The housing 11 houses various members configuring the recording device 10.

The recording device 10 includes an operation panel 18. The operation panel 18 may be provided on the front surface 12. The operation panel 18 may be a touch panel. The operation panel 18 may include an operation section 18A and a display section 18B. The operation section 18A is operable by a user. The operation section 18A may be configured by a plurality of operation regions. The display section 18B displays information concerning the recording device 10.

The recording device 10 includes a paper discharge tray 19. The paper discharge tray 19 is a tray on which the medium 90 discharged after recording is placed. The paper discharge tray 19 is accessible from the front direction Y1. The paper discharge tray 19 may be configured to be capable of extending and contracting in the front-rear direction Y.

The recording device 10 includes a storage cassette 20. The storage cassette 20 configures a part of the front surface 12. The storage cassette 20 is housed in the housing 11. The storage cassette 20 is displaceable in the front-rear direction Y. The storage cassette 20 is capable of feeding paper by being moved in the front direction Y1 from the housing 11. The storage cassette 20 stores the medium 90.

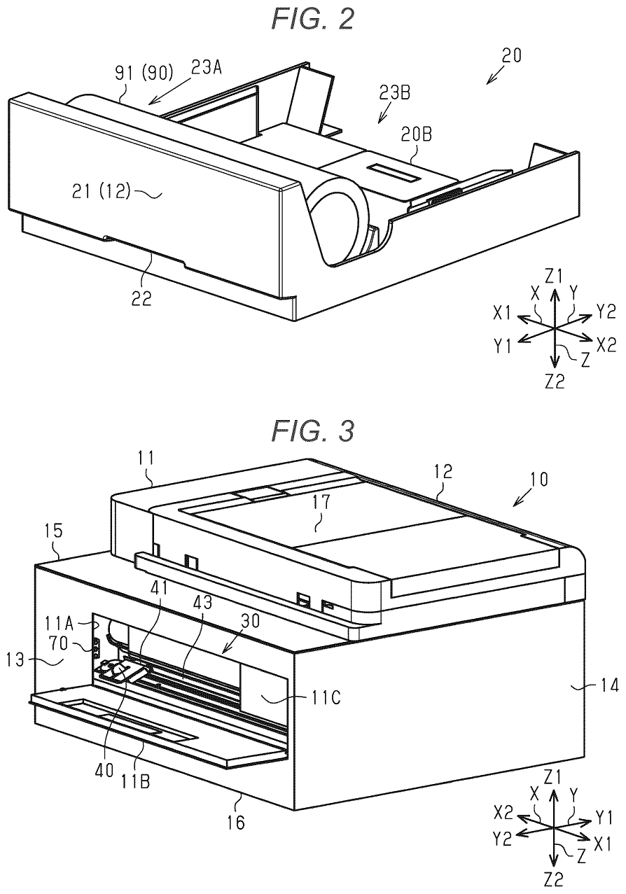

As illustrated in FIG. 2, the storage cassette 20 includes a front surface section 21, a cassette gripping section 22, a first storage section 23A, and a second storage section 23B. The front surface section 21 is a wall section located on the front direction Y1. The front surface section 21 configures a part of the front surface 12. The cassette gripping section 22 is provided in the front surface section 21. The cassette gripping section 22 can be gripped by the user.

The first storage section 23A is configured to store the roll paper 91 as the medium 90. The roll paper 91 is equivalent to an example of a first medium. The second storage section 23B is configured to store the paper 92 illustrated in FIG. 4 as the medium 90. The paper 92 is equivalent to an example of a second medium. Any one of the roll paper 91 placed on the first storage section 23A and the paper 92 placed on the second storage section 23B may be configured to be feedable.

As illustrated in FIG. 3, the housing 11 includes an opening section 11A and an opening and closing cover 11B. The opening section 11A is provided in the rear surface 13. The opening section 11A enables access to a cutting section 30 housed in the housing 11.

The opening and closing cover 11B is a cover for enabling the opening section 11A to open and close. The opening and closing cover 11B is pivotally attached to the downward direction Z2 of the opening section 11A but is not limited to this and may be pivotally attached to, for example, the upward direction Z1 of the opening section 11A. As explained above, the opening and closing cover 11B is opened, whereby the housing 11 enables access to the cutting section 30 via the opening section 11A.

Specifically, it is possible to, for example, eliminate clogging of the medium 90 and perform maintenance of the cutting section 30. The maintenance of the cutting section 30 includes replacement of a cutter unit 40 explained below.

### Configuration of a Cover Lock Section 70

The recording device 10 includes a cover lock section 70. The cover lock section 70 is provided in the housing 11. The cover lock section 70 is located in a region where the opening section 11A is provided. The cover lock section 70 locks the opening and closing cover 11B in a state in which the opening and closing cover 11B is closed when the opening section 11A is closed. The cover lock section 70 may be an electromagnetic solenoid.

Specifically, the cover lock section 70 includes a displaceable lock shaft. The cover lock section 70 locks the opening and closing cover 11B in a state in which the opening section 11A is closed by inserting a lock shaft into (not illustrated) provided in the opening and closing cover 11B. The lock shaft retracts from a not-illustrated recess provided in the opening and closing cover 11B, whereby the cover lock section 70 unlocks the opening and closing cover 11B.

The cover lock section 70 is configured to lock the opening and closing cover 11B when a power supply of the recording device 10 is off. When the power supply of the recording device 10 is on, the cover lock section 70 locks the opening and closing cover 11B and unlocks the opening and closing cover 11B according to an instruction from the user. When the power supply of the recording device 10 is on, the cover lock section 70 locks the opening and closing cover 11B according to an instruction from the user in a state in which the opening and closing cover 11B is unlocked.

As explained above, the cover lock section 70 restricts the opening of the opening and closing cover 11B by locking the opening and closing cover 11B in a state in which the opening section 11A closed. When the opening and closing cover 11B is closed, access to the cutting section 30 is restricted via the opening section 11A. That is, the cover lock section 70 restricts access to the cutting section 30. The cover lock section 70 is equivalent to an example of a restriction section.

### Configuration of a Feeding Section 31

As illustrated in FIG. 4, the recording device 10 includes the cutting section 30, a feeding section 31, a conveyance section 32, a recording section 33, a medium support section 34, and a control section 35. The feeding section 31 is located in the upward direction Z1 of the storage cassette 20 when the storage cassette 20 is attached to the housing 11. The feeding section 31 is configured to feed the medium 90 placed in the storage cassette 20.

The feeding section 31 includes a feeding roller 31A and a roller support section 31B. The feeding roller 31A is a roller for feeding the medium 90. The roller support section 31B is pivotally attached to be rotatable centering on a rotating shaft 31C at a proximal end portion. The rotating shaft 31C is a shaft extended in the width direction X. The roller support section 31B is configured to rotatably support the feeding roller 31A at the distal end portion. The roller support section 31B inclines such that the feeding roller 31A comes into contact with the medium 90.

The storage cassette 20 includes a feeding path 20A for the roll paper 91. The feeding path 20A is located in the downward direction 22 of the first storage section 23A and the second storage section 23B. The feeding path 20A is a path that connects the first storage section 23A and a conveyance path 24 explained below.

The storage cassette 20 includes a feeding flap 20B. The feeding flap 20B is provided on a support plate of the second storage section 23B. The feeding flap 20B is displaced to a paper position and a roll paper position. The feeding flap 20B may be displaced by rotation or may be displaced by slide.

The paper position is a position at the time when recording is performed on the paper 92 stored in the second storage section 23B. The paper position is a position where the paper 92 stored in the second storage section 23B is supported by closing an opening or a notch provided in the bottom plate of the second storage section 23B.

The roll paper position is a position at the time when recording is performed on the roll paper 91 stored in the first storage section 23A. The roll paper position is a position where the feeding roller 31A is brought into contact with the roll paper 91 on the feeding path 20A by opening the opening or the notch provided in the bottom plate of the second storage section 23B.

When the paper 92 is stored in the second storage section 23B, the feeding roller 31A comes into contact with the paper 92 according to the inclination of the roller support section 31B. Specifically, the feeding roller 31A comes into contact with the paper 92 placed on the upward direction Z1 most among pieces of the paper 92 stored in the second storage section 23B. The feeding roller 31A rotates in a feeding direction in a state of being in contact with the paper 92 to thereby feed the pieces of paper 92 in contact with the feeding roller 31A one by one. In this case, the feeding flap 20B is disposed at the paper position. For this reason, the second storage section 23B can stably store the paper 92.

When the feeding flap 20B is disposed at the roll paper position and the paper 92 is not stored in the second storage section 23B, according to the inclination of the roller support section 31B, the feed roller 31A comes into contact with the roll paper 91 disposed on the feed path 20A. The feeding roller 31A rotates in the feeding direction in a state of being in contact with the roll paper 91 on the feeding path 20A to thereby feed the roll paper 91 that is in contact with the feeding roller 31A.

### Configuration of the Conveyance Section 32

The conveyance section 32 is configured to convey the medium 90. The conveyance section 32 conveys the medium 90, which is fed by the feeding section 31, in a conveyance direction D along the conveyance path 24. The conveyance path 24 is a path for conveying the medium 90.

The conveyance path 24 may include a path for conveying the roll paper 91 and a path for conveying the paper 92. The conveyance path 24 may include a reversing path 24A for reversing the medium 90. The reversing path 24A is a path for conveying the medium 90 reversed by a reversing section 28 explained below.

The conveyance section 32 includes a plurality of rollers and a plurality of motors serving as drive sources. In particular, the conveyance section 32 includes a conveyance roller pair 25. The conveyance roller pair 25 is located upstream of the medium support section 34 in the conveyance path 24. The conveyance roller pair 25 conveys the medium 90 to the medium support section 34 along the conveyance path 24.

The conveyance section 32 includes a first discharge roller pair 26 and a second discharge roller pair 27. The first discharge roller pair 26 and the second discharge roller pair 27 are located downstream of the medium support section 34 in the conveyance path 24. The second discharge roller pair 27 is located downstream of the first discharge roller pair 26 in the conveyance path 24. The first discharge roller pair 26 and the second discharge roller pair 27 discharge the medium 90 after recording along the conveyance path 24.

The conveyance section 32 may include a reversing section 28. That is, the recording device 10 includes the reversing section 28. The reversing section 28 is configured to reverse the medium 90 after recording. The second discharge roller pair 27 conveys the medium 90 after recording to the reversing section 28 along the reversing path 24A by rotating in a direction opposite to a rotation direction in which the medium 90 after recording is discharged. The reversing section 28 is configured to reverse the medium 90 after recording conveyed to the second discharge roller pair 27.

The reversing section 28 includes a reversing flap 29. The reversing flap 29 is provided at a position along the reversing path 24A. The reversing flap 29 switches the direction in which the medium 90 is conveyed. In particular, the reversing flap 29 switches whether to convey the medium 90 along the reversing path 24A. As explained above, the reversing section 28 causes the reversed medium 90 after recording to merge upstream of the medium support section 34 in the conveyance path 24.

Accordingly, the medium 90, on the surface of which an image is recorded, is conveyed to the medium support section 34 in a state of being reversed by the reversing section 28. Accordingly, an image can be recorded also on the rear surface of the medium 90 by the recording section 33. As explained above, the recording section 33 is capable of performing recording on both the surfaces of the medium 90. That is, the recording section 33 is capable of performing duplex printing.

### Configuration of the Recording Section 33

The recording section 33 is configured to record an image on the medium 90. The recording section 33 may be configured to record an image on the medium 90 by discharging liquid onto the medium 90. The recording section 33 is located in the upward direction Z1 of the medium support section 34.

The recording section 33 includes a recording carriage 36 and a liquid discharge head 37. The recording carriage 36 supports the liquid discharge head 37 from the upward direction Z1. The liquid discharge head 37 is provided in the downward direction 22 of the recording carriage 36.

The liquid discharge head 37 includes a nozzle surface 38. The nozzle surface 38 is a surface facing the downward direction Z2. The nozzle surface 38 is a surface facing the medium support section 34. The nozzle surface 38 is a surface on which a not-illustrated plurality of nozzles are opened. Each of the plurality of nozzles is opened toward the medium 90 supported by the medium support section 34. Each of the plurality of nozzles discharges liquid.

The liquid discharge head 37 discharges liquid from the plurality of nozzles toward the medium 90 supported by the medium support section 34. As explained above, the recording section 33 is configured to perform recording on the medium 90 by ejecting liquid onto the medium 90. The liquid discharge head 37 is a serial head type that discharges liquid according to the movement of the recording carriage 36 in the width direction X but may be a line head type.

The medium support section 34 is configured to support the medium 90. In particular, the medium support section 34 supports the medium 90 in a recording region where recording is performed on the medium 90 by the recording section 33. That is, the medium support section 34 supports the medium 90 on which recording is performed by the recording section 33.

### Configuration of the Control Section 35

The control section 35 controls the recording device 10. The control section 35 controls the sections in the recording device 10. The control section 35 controls various operations executed by the recording device 10. The control section 35 may be communicably connected to a not-illustrated terminal device.

The control section 35 can be configured as a: one or more processors that execute various kinds of processing according to a computer program, B: one or more dedicated hardware circuits that execute at least a part of the various kinds of processing, or y: a circuit including a combination of the processors and the dedicated hardware circuits. The hardware circuit is, for example, an application specific integrated circuit. The processor includes a CPU and memories such as a RAM and a ROM. The memories store program codes or commands configured to cause the CPU to execute the processing. The memories, that is, computer-readable media include all readable media that can be accessed by a general-purpose or dedicated computer.

### Configuration of the Cutting Section 30

The cutting section 30 is configured to cut the medium 90. The cutting section 30 is provided on the rear surface 13 side of the recording device 10. The cutting section 30 is provided at a position along the conveyance path 24. The cutting section 30 is configured to cut, in the width direction X, the roll paper 91 conveyed along the conveyance path 24.

The cutting section 30 is provided at a position along the conveyance path 24 between the feeding section 31 and the recording section 33 but may be provided at a position along the conveyance path 24 between the recording section 33 and the paper discharge tray 19.

The cutting section 30 is located in the front direction Y1 of the opening section 11A. The cutting section 30 is exposed via the opening section 11A in a state in which the opening and closing cover 11B is opened. Accordingly, the cutting section 30 can be accessed by the user via the opening section 11A in a state in which the opening and closing cover 11B is opened.

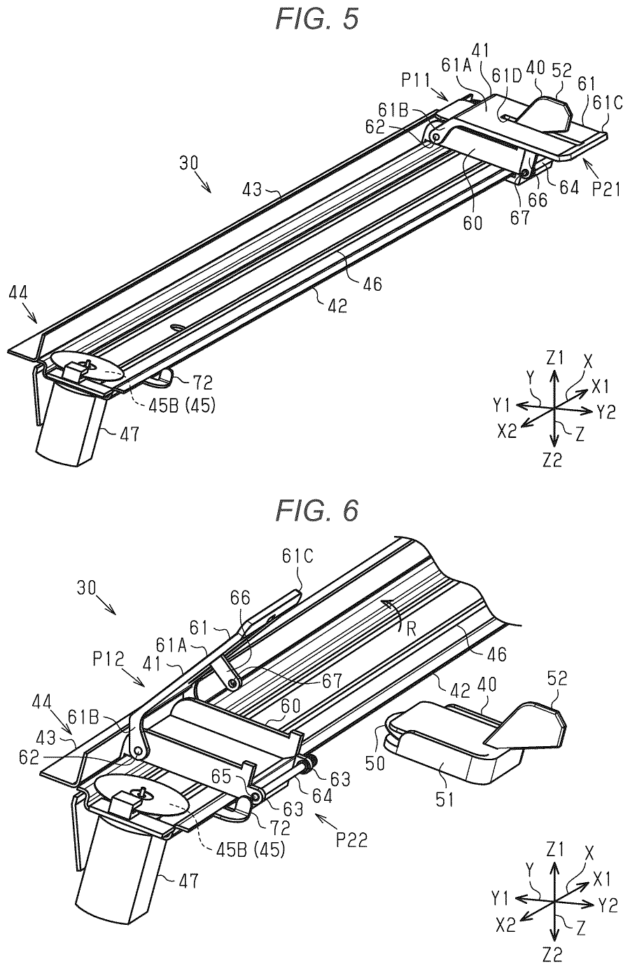

As illustrated in FIGS. 5 to 10, the cutting section 30 is disposed to incline upward toward the front direction Y1 but may be disposed along the front-rear direction Y. In the following explanation, the front-rear direction Y and the vertical direction Z are on the assumption that the cutting section 30 is disposed along the front-rear direction Y.

The cutting section 30 includes a cutter unit 40, a cutter carriage 41, a carriage support section 42, a fixed blade 43, and a carriage moving section 44. That is, the recording device 10 includes the cutter unit 40, the cutter carriage 41, the carriage support section 42, the fixed blade 43, and the carriage moving section 44.

The cutter unit 40 is a unit for cutting the medium 90. The cutter unit 40 is mounted on the cutter carriage 41. The cutter unit 40 is detachably attachable to the cutter carriage 41. In other words, the cutter carriage 41 is capable of detachably attach the cutter unit 40.

The cutter carriage 41 is movable in the width direction X with a driving force from the carriage moving section 44 in a state of being supported by the carriage support section 42. The cutter carriage 41 moves the cutter unit 40 in the width direction X intersecting the conveyance direction D in a state in which the cutter unit 40 is attached to the cutter carriage 41.

At least the cutter unit 40 and the cutter carriage 41 are housed in the housing 11. That is, the housing 11 houses at least the cutter unit 40 and the cutter carriage 41. At least the cutter unit 40 and the cutter carriage 41 can be accessed via the opening section 11A. That is, the housing 11 enables operation of removing the cutter unit 40 from the cutter carriage 41 via the opening section 11A.

The carriage support section 42 extends in the width direction X. The carriage support section 42 is configured to support the cutter carriage 41. The carriage support section 42 guides the cutter carriage 41 to be movable in the width direction X.

The fixed blade 43 is extended in the width direction X. The fixed blade 43 may be configured in an L shape when viewed from the first width direction X1. The fixed blade 43 is provided at a position facing a cutter blade 50 of the cutter unit 40 across the conveyance path 24. Thus, the cutter blade 50 and the fixed blade 43 cut the medium 90 conveyed along the conveyance path 24.

As illustrated in FIGS. 5 and 6, the carriage moving section 44 includes a pair of pulleys 45, a timing belt 46, and a carriage driving section 47. The pair of pulleys 45 is provided at both end portions of the carriage support section 42 in the width direction X. The pair of pulleys 45 includes a first pulley 45A and a second pulley 45B. The first pulley 45A is provided at the end portion in the first width direction X1 of the carriage support section 42. The second pulley 45B is provided at the end portion in the second width direction X2 of the carriage support section 42.

The timing belt 46 is wound around the pair of pulleys 45. The timing belt 46 may be an endless belt. The timing belt 46 is coupled to the cutter carriage 41.

The carriage driving section 47 is a drive source for moving the cutter carriage 41 in the width direction X. The carriage driving section 47 may be a motor. The carriage driving section 47 may be provided at the end portion in the second width direction X2 of the carriage support section 42. The carriage driving section 47 may rotate the second pulley 45B via a not-illustrated transmission member. Accordingly, the carriage driving section 47 moves the cutter carriage 41 in the width direction X.

The cutting section 30 may include a not-illustrated position detection section. The position detection section detects the position of the cutter carriage 41 in the width direction X. The position detection section may be an encoder that detects the position of the cutter carriage 41 by detecting an amount of rotation of at least one of the pair of pulleys 45. The position detection section may be an encoder that detects the position of the cutter carriage 41 by detecting position information in the width direction X of the cutter carriage 41. The position detection section outputs a signal indicating the detection result to the control section 35.

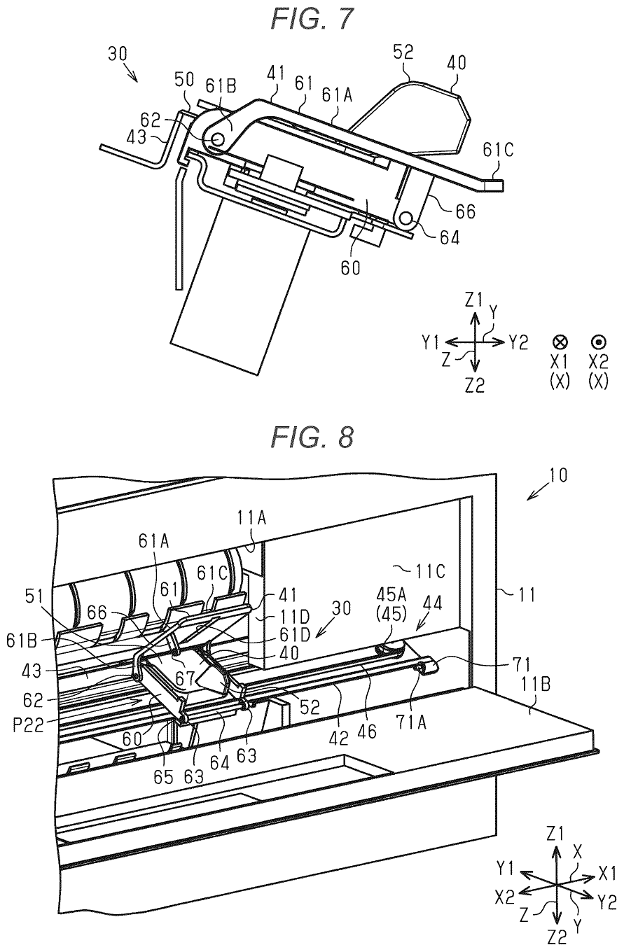

As illustrated in FIGS. 6 and 7, the cutter unit 40 includes a cutter blade 50 and a cutter housing section 51. The cutter blade 50 is a member for cutting the medium 90 in the conveyance path 24. The cutter housing section 51 can house the cutter blade 50 in an exposed state.

The cutter housing section 51 includes a positioning section 52. The positioning section 52 is a member for positioning the cutter unit 40 with respect to the cutter carriage 41. The positioning section 52 is configured to protrude in the upward direction Z1. The positioning section 52 may have a plate shape extending in the front-rear direction Y and the vertical direction Z.

As illustrated in FIGS. 5 and 6, the cutter carriage 41 is movable between a standby position P11 and an attachment and detachment position P12. The cutter carriage 41 is movable between the standby position P11 and the attachment and detachment position P12 according to an instruction from the user.

The standby position P11 is located on the first width direction X1 side. The standby position P11 is a home position where the cutter carriage 41 stays on standby when the cutting section 30 is not operating. The attachment and detachment position P12 is located on the second width direction X2 side. The attachment and detachment position P12 is a position at the time when the cutter unit 40 is attached to and detached from the cutter carriage 41.

The cutter carriage 41 includes a unit holding section 60 and a unit fixing section 61. The unit holding section 60 holds the cutter unit 40. The unit holding section 60 is movable in the width direction X with a driving force from the carriage moving section 44.

The unit holding section 60 includes a pair of lock holding sections 63 and a unit lock section 64. The pair of lock holding sections 63 is provided side by side in the width direction X. The lock holding section 63 may be configured to protrude in the rear direction Y2. The pair of lock holding sections 63 holds the unit lock section 64 to be movable in the width direction X.

The lock holding section 63 includes a through hole 65. The through hole 65 is provided to penetrate the lock holding section 63 in the width direction X. The unit lock section 64 is inserted into the through hole 65, whereby the through hole 65 holds the unit lock section 64 to be movable in the width direction X.

The unit lock section 64 has a bar shape. The unit lock section 64 is held by the unit lock section 64 by being inserted into the through hole 65. The unit lock section 64 is held by the unit lock section 64 to be movable in the width direction X. The unit lock section 64 is a bolt.

The unit fixing section 61 fixes the cutter unit 40 together with the unit holding section 60 by coming into contact with, from the upward direction Z1, the cutter unit 40 held by the unit holding section 60. That is, the unit fixing section 61 fixes the cutter unit 40 when the cutter unit 40 is attached.

The unit fixing section 61 includes a main body section 61A, a pair of arm sections 61B, and a gripping section 61C. The main body section 61A has a flat plate shape. The main body section 61A is a part for fixing the cutter unit 40 by coming into contact with, from the upward direction Z1, the cutter unit 40 held by the unit holding section 60.

The arm section 61B is provided in the front direction Y1 of the main body section 61A. The pair of arm sections 61B is provided side by side in the width direction X. An opening is provided at the distal end portion of the arm section 61B. A coupling shaft 62 provided in the main body section 61A is inserted into the opening. The coupling shaft 62 is a shaft protruding to the outer side of the unit holding section 60 along the width direction X.

Accordingly, the unit fixing section 61 is capable of rotating with respect to the unit holding section 60 centering on a rotation axis along the width direction X. The unit fixing section 61 is movable between a fixing position P21 and a release position P22.

That is, the unit fixing section 61 is movable between the fixing position P21 and the release position P22 in a state in which the cutter unit 40 is attached. The unit fixing section 61 is further movable to the release position P22 by moving in a release direction R from the fixing position P21.

The fixing position P21 is a position where the cutter unit 40 held by the unit holding section 60 is fixed. The fixing position P21 is a position where the unit fixing section 61 comes into contact with, from the upward direction Z1, the cutter unit 40 held by the unit holding section 60.

The release position P22 is a position where the cutter unit 40 held by the unit holding section 60 is not fixed and the fixing of the cutter unit 40 is released. The release position P22 is a position where the unit fixing section 61 does not come into contact with, from the upper side Z1, the cutter unit 40 held by the unit holding section 60. The release position P22 is a position where the cutter unit 40 held by the unit holding section 60 can be attached and detached.

The gripping section 61C is provided in the rear direction Y2 of the main body section 61A. The gripping section 61C is a part that can be gripped by the user when the unit fixing section 61 is moved. As explained above, the unit fixing section 61 is movable by being gripped by the user.

The main body section 61A includes a positioning opening section 61D. The positioning opening section 61D is extended along the front-rear direction Y. When the unit fixing section 61 moves between the fixing position P21 and the release position P22 in a state in which the cutter unit 40 is held by the unit holding section 60, the positioning section 52 is inserted into and removed from the positioning opening section 61D.

When the unit fixing section 61 is disposed at the fixing position P21 in the state in which the cutter unit 40 is held by the unit holding section 60, the positioning section 52 is inserted into the positioning opening section 61D. Accordingly, the cutter unit 40 is positioned in the cutter carriage 41 when the cutter unit 40 is attached to the cutter carriage 41.

The unit fixing section 61 includes a locked section 66. The locked section 66 may be provided in the main body section 61A. The locked section 66 may be provided in the second width direction X2 of the main body section 61A. The locked section 66 may be extended from the main body section 61A in the downward direction Z2.

The locked section 66 includes a lock hole 67. The lock hole 67 is provided to penetrate the locked section 66 in the width direction X. The unit lock section 64 is inserted into the lock hole 67, whereby, the lock hole 67 is capable of holding the unit lock section 64.

As explained above, the unit lock section 64 can lock the unit fixing section 61 at the fixing position P21 by being inserted into the lock hole 67 in a state in which the unit fixing section 61 is disposed at the fixing position P21. That is, the unit lock section 64 can lock the unit fixing section 61 with respect to the unit holding section 60 in a state in which the unit fixing section 61 is disposed at the fixing position P21. Accordingly, when the cutter unit 40 is attached to the cutter carriage 41, the cutter unit 40 cannot be removed from the cutter carriage 41. The unit lock section 64 corresponds to an example of a restriction section.

### Configuration of a First Contact Section 71

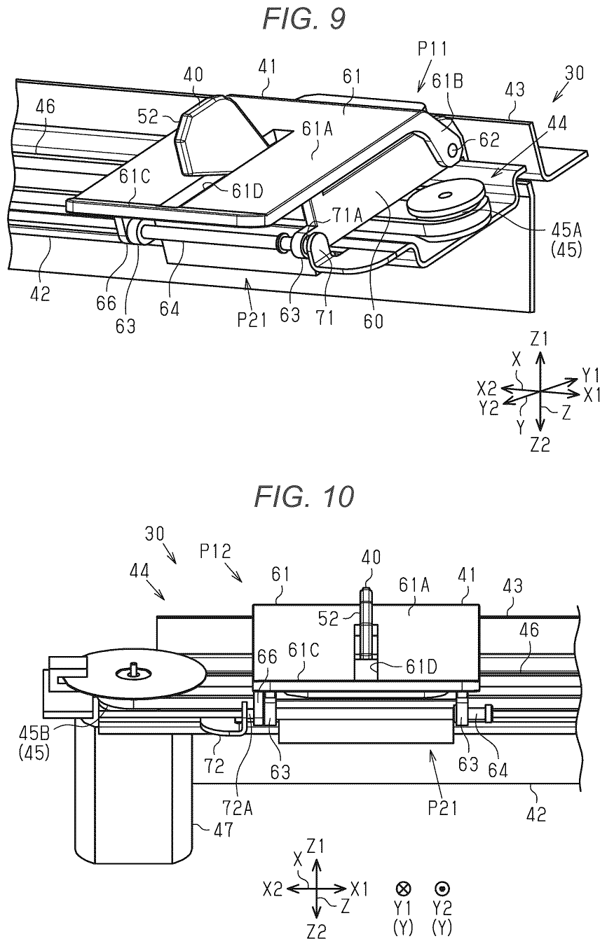

As illustrated in FIGS. 8 and 9, the cutting section 30 includes a first contact section 71. That is, the recording device 10 includes the first contact section 71. The first contact section 71 is provided in a carriage support section 42. The first contact section 71 is provided on the first width direction X1 side in a movement range of the cutter carriage 41. The first contact section 71 is provided at a position in contact with the unit lock section 64 in the first width direction X1 when the cutter carriage 41 is disposed at the standby position P11.

The first contact section 71 may include a first protruding section 71A. The first protruding section 71A protrudes in the second width direction X2. The first protruding section 71A is capable of coming into contact with the unit lock section 64 from the first width direction X1 side. As explained above, the first contact section 71 is capable of coming into contact with the unit lock section 64 from the first width direction X1 side.

When the cutter carriage 41 moves from the attachment and detachment position P12 to the standby position P11, the first contact section 71 moves the unit lock section 64 in the second width direction X2 by coming into contact with the unit lock section 64 from the first width direction X1 side. Accordingly, the unit lock section 64 is inserted into the lock hole 67.

As explained above, when the cutter carriage 41 moves from the attachment and detachment position P12 to the standby position P11, the first contact section 71 causes the unit lock section 64 to lock the unit fixing section 61 by coming into contact with the unit lock section 64.

### Configuration of a Second Contact Section 72

As illustrated in FIG. 10, the cutting section 30 includes a second contact section 72. That is, the recording device 10 includes the second contact section 72. The second contact section 72 is provided on the carriage support section 42. The second contact section 72 is provided on the second width direction X2 side in the movement range of the cutter carriage 41. The second contact section 72 is provided at a position in contact with the unit lock section 64 in the second width direction X2 when the cutter carriage 41 is disposed at the attachment and detachment position P12.

The second contact section 72 may include a second protruding section 72A. The second protruding section 72A protrudes in the first width direction X1. The second protruding section 72A is capable of coming into contact with the unit lock section 64 from the second width direction X2 side. As explained above, the second contact section 72 is capable of coming into contact with the unit lock section 64 from the second width direction X2 side.

When the cutter carriage 41 moves from the standby position P11 to the attachment and detachment position P12, the second contact section 72 moves the unit lock section 64 in the first width direction X1 by coming into contact with the unit lock section 64 from the second width direction X2 side. Accordingly, the unit lock section 64 retracts from the lock hole 67.

As explained above, when the cutter carriage 41 moves from the standby position P11 to the attachment and detachment position P12, the second contact section 72 causes the unit lock section 64 to unlock the unit fixing section 61 by coming into contact with the unit lock section 64.

### Configuration of a Restriction Wall 11C

As illustrated in FIG. 8, the housing 11 includes a restriction wall 11C. The restriction wall 11C is located in the rear direction Y2 of the standby position P11 where the cutter unit 40 is disposed. That is, the restriction wall 11C is provided between the cutter unit 40 disposed at the standby position P11 and the opening section 11A.

A gap is provided in the front direction Y1 of the restriction wall 11C. The gap is a space in which the cutter unit 40 is movable in the width direction X but the user cannot remove the cutter unit 40. The restriction wall 11C does not restrict movement of the cutter unit 40 along the width direction X.

As explained above, when the cutter unit 40 is disposed at the standby position P11 in a state in which the opening section 11A is opened, the restriction wall 11C restricts operation of removing the cutter unit 40 from the cutter carriage 41 via the opening section 11A.

When the cutter unit 40 moves from the attachment and detachment position P12 toward the standby position P11 in a state in which the unit fixing section 61 is disposed at the release position P22, the unit fixing section 61 comes into contact with a side portion 11D of the restriction wall 11C. Accordingly, the cutter unit 40 is not disposed at the standby position P11. As explained above, the restriction wall 11C restricts movement of the cutter unit 40 to the standby position P11 by coming into contact with the unit fixing section 61. The restriction wall 11C is equivalent to an example of a restriction section.

### Replacement Control Processing

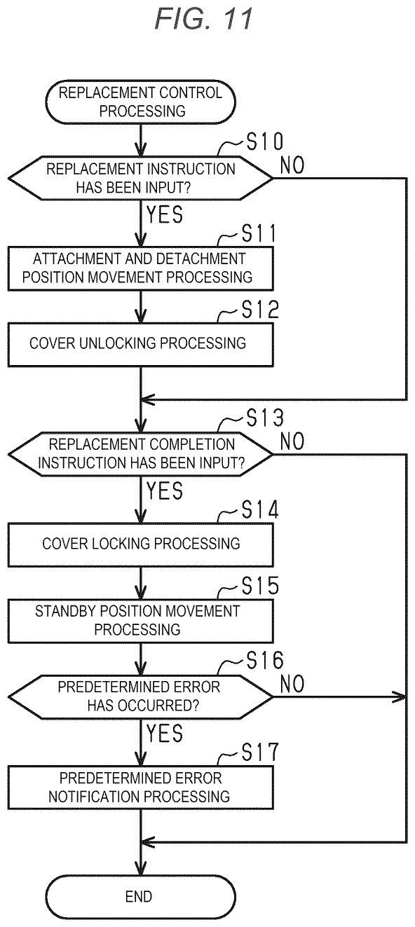

Subsequently, replacement control processing is explained with reference to FIG. 11. The replacement control processing is processing executed by the control section 35 at every predetermined period.

As illustrated in FIG. 11, in step S10, the control section 35 determines whether a replacement instruction has been input. The replacement instruction is an instruction by the user. The instruction by the user is an instruction from the operation section 18A but may be an instruction from a not-illustrated terminal device.

When determining that a replacement instruction has not been input, the control section 35 shifts the processing to step S13. When determining that a replacement instruction has been input, the control section 35 shifts the processing to step S11.

In step S11, the control section 35 executes attachment and detachment position movement processing. In this processing, the control section 35 controls the carriage moving section 44 to move the cutter carriage 41 from the standby position P11 to the attachment and detachment position P12. Accordingly, the cutter carriage 41 moves from the standby position P11 to the attachment and detachment position P12 according to an instruction from the user.

When the cutter carriage 41 moves to the attachment and detachment position P12, the second contact section 72 comes into contact with the unit lock section 64. Accordingly, the unit lock section 64 retracts from the lock hole 67. Thus, the lock of the unit fixing section 61 by the unit lock section 64 is released. As explained above, the unit lock section 64 unlocks the unit fixing section 61.

In step S12, the control section 35 executes cover unlocking processing. In this processing, the control section 35 controls the cover lock section 70 to unlock the opening and closing cover 11B. As explained above, the cover lock section 70 unlocks the opening and closing cover 11B according to an instruction from the user.

In step S13, the control section 35 determines whether a replacement completion instruction has been input. The replacement completion instruction is an instruction by the user. When determining that a replacement completion instruction has not been input, the control section 35 ends the replacement control processing. When determining that a replacement completion instruction has been input, the control section 35 proceeds to step S14.

In step S14, the control section 35 executes cover lock processing. In this processing, the control section 35 controls the cover lock section 70 to lock the opening and closing cover 11B. As explained above, the cover lock section 70 locks the opening and closing cover 11B according to an instruction from the user.

In step S15, the control section 35 executes standby position movement processing. In this processing, the control section 35 controls the carriage moving section 44 to move the cutter carriage 41 from the attachment and detachment position P12 to the standby position P11. Accordingly, the cutter carriage 41 moves from the attachment and detachment position P12 to the standby position P11 according to an instruction from the user.

When the cutter carriage 41 moves to the standby position P11, the first contact section 71 comes into contact with the unit lock section 64. Accordingly, the unit lock section 64 is inserted into the lock hole 67. Thus, the unit fixing section 61 is locked by the unit lock section 64. As explained above, the unit lock section 64 locks the unit fixing section 61.

In step S16, the control section 35 determines whether a predetermined error has occurred. The predetermined error is an error concerning movement of the cutter carriage 41. The predetermined error occurs when the cutter carriage 41 does not move to the standby position P11 even if a predetermined time has passed from the input of the replacement completion instruction.

When determining that the predetermined error has not occurred, the control section 35 ends the replacement control processing. When determining that the predetermined error has occurred, the control section 35 shifts the processing to step S17.

In step S17, the control section 35 executes predetermined error notification processing. In this processing, the control section 35 stops the movement of the cutter carriage 41. The control section 35 performs notification concerning the occurrence of the predetermined error by causing the display section 18B to display information on the occurrence of the predetermined error.

The control section 35 may perform the notification concerning the occurrence of the predetermined error by outputting information concerning the occurrence of the predetermined error from a not-illustrated speaker. The control section 35 may perform the notification concerning the occurrence of the predetermined error by causing a not-illustrated error lamp to emit light to indicate the information concerning the occurrence of the predetermined error. The control section 35 may perform the notification concerning the occurrence of the predetermined error in a terminal device by transmitting the information concerning the occurrence of the predetermined error to the terminal device.

### Action and Effects of the First Embodiment

Action and effects of the first embodiment are explained.

(1-1) Removal of the cutter unit 40 from the cutter carriage 41 is restricted. With this configuration, it is possible to restrict removal of the cutter unit 40 having the cutter blade 50 from the cutter carriage 41. Accordingly, it is possible to prevent the user from unintentionally removing the cutter unit 40 from the cutter carriage 41. Therefore, safety for the cutter blade 50 can be improved.

(1-2) The cover lock section 70 locks the opening and closing cover 11B in a state in which the opening section 11A is closed. With this configuration, the opening and closing cover 11B is locked in the state in which the opening section 11A is closed, whereby the operation of removing the cutter unit 40 from the cutter carriage 41 can be restricted. Accordingly, it is possible to prevent the user from unintentionally removing the cutter unit 40 from the cutter carriage 41. Therefore, safety for the cutter blade 50 can be improved.

(1-3) The cover lock section 70 unlocks the opening and closing cover 11B according to an instruction from the user. With this configuration, by unlocking the opening and closing cover 11B as intended by the user, it is possible to enable operation of removing the cutter unit 40 from the cutter carriage 41. Accordingly, it is possible to prevent the user from unintentionally removing the cutter unit 40 from the cutter carriage 41. Therefore, safety for the cutter blade 50 can be improved.

(1-4) The restriction wall 11C restricts operation of removing the cutter unit 40 from the cutter carriage 41 via the opening section 11A when the cutter carriage 41 is disposed at the standby position P11 in a state in which the opening section 11A is opened. With this configuration, with the restriction wall 11C, it is possible to restrict operation of removing the cutter unit 40 from the cutter carriage 41. Accordingly, it is possible to prevent the user from unintentionally removing the cutter unit 40 from the cutter carriage 41. Therefore, safety for the cutter blade 50 can be improved.

(1-5) The cutter carriage 41 moves from the standby position P11 to the attachment and detachment position P12 according to an instruction from the user. With this configuration, by moving the cutter carriage 41 from the standby position P11 to the attachment and detachment position P12 as intended by the user, it is possible to enable operation of removing the cutter unit 40 from the cutter carriage 41. Accordingly, it is possible to prevent the user from unintentionally removing the cutter unit 40 from the cutter carriage 41. Therefore, safety for the cutter blade 50 can be improved.

(1-6) When the cutter carriage 41 moves from the attachment and detachment position P12 toward the standby position P11 in a state in which the unit fixing section 61 is disposed at the release position P22, the restriction wall 11C comes into contact with the unit fixing section 61. Accordingly, the restriction wall 11C restricts movement of the cutter carriage 41 to the standby position P11. With this configuration, in a state in which the unit fixing section 61 is disposed at the release position P22, it is possible to restrict movement of the cutter carriage 41 from the attachment and detachment position P12 to the standby position P11. It is possible to make it easy for the user to recognize that the unit fixing section 61 is not disposed at the fixing position P21. Accordingly, it is possible to prevent the user from unintentionally removing the cutter unit 40 from the cutter carriage 41. Therefore, safety for the cutter blade 50 can be improved.

(1-7) By coming into contact with the unit lock section 64, the first contact section 71 causes the unit lock section 64 to lock the unit fixing section 61. With this configuration, the first contact section 71 can lock the unit fixing section 61 at the fixing position P21 by coming into contact with the unit lock section 64. Accordingly, it is possible to prevent the user from unintentionally removing the cutter unit 40 from the cutter carriage 41. Therefore, safety for the cutter blade 50 can be improved.

(1-8) By coming into contact with the unit lock section 64, the second contact section 72 causes the unit lock section 64 to unlock the unit fixing section 61. With this configuration, the second contact section 72 can unlock the unit fixing section 61 by coming into contact with the unit lock section 64. In such a case, it is possible to move the unit fixing section 61 to the release position P22 and enable operation of removing the cutter unit 40 from the cutter carriage 41. Accordingly, it is possible to prevent the user from unintentionally removing the cutter unit 40 from the cutter carriage 41. Therefore, safety for the cutter blade 50 can be improved.

(1-9) When the cutter carriage 41 moves from the attachment and detachment position P12 to the standby position P11, by coming into contact with the unit lock section 64, the first contact section 71 causes the unit lock section 64 to lock the unit fixing section 61. With this configuration, when the cutter carriage 41 moves from the attachment and detachment position P12 to the standby position P11, the first contact section 71 can lock the unit fixing section 61 by coming into contact with the unit lock section 64. Accordingly, it is possible to prevent the user from unintentionally removing the cutter unit 40 from the cutter carriage 41 and it is possible to switch the lock of the unit fixing section 61 according to the movement of the cutter carriage 41. Therefore, safety for the cutter blade 50 can be improved.

(1-10) When the cutter carriage 41 moves from the standby position P11 to the attachment and detachment position P12, by coming into contact with the unit lock section 64, the second contact section 72 causes the unit lock section 64 to unlock the unit fixing section 61. With this configuration, when the cutter carriage 41 moves from the standby position P11 to the attachment and detachment position P12, the second contact section 72 can unlock the unit fixing section 61 by coming into contact with the unit lock section 64. Accordingly, it is possible to prevent the user from unintentionally removing the cutter unit 40 from the cutter carriage 41 and it is possible to switch the lock of the unit fixing section 61 according to the movement of the cutter carriage 41. Therefore, safety for the cutter blade 50 can be improved.

### Second Embodiment

Subsequently, a second embodiment is explained. In the following explanation, redundant explanation is omitted or simplified about the same components as the components in the embodiment explained above. Components different from the components in the embodiment explained above are explained.

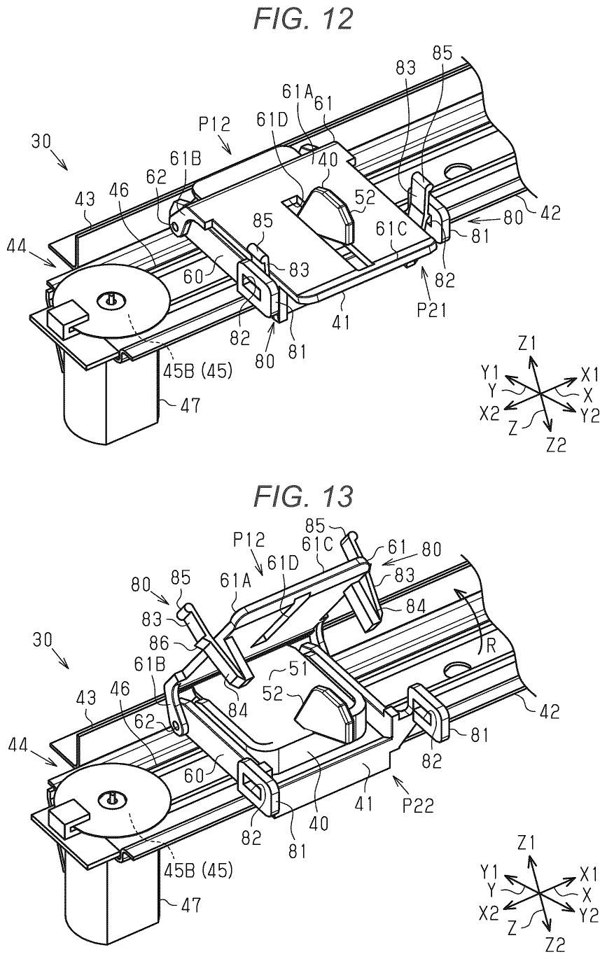

As illustrated in FIGS. 12 and 13, in the second embodiment, the cutter carriage 41 includes a unit lock section 80. The unit lock section 80 can lock the unit fixing section 61 in a state of being disposed at the fixing position P21. The unit lock section 80 may include a displacement section 83 explained below.

The unit holding section 60 includes a pair of locked sections 81. The pair of locked sections 81 is provided side by side in the width direction X. The pair of locked sections 81 is provided on the outer side of the unit holding section 60 in the width direction X. The locked section 81 is provided at a position close to the rear direction Y2 side of the unit holding section 60. The locked section 81 includes a through hole 82. The through hole 82 is fitted with a protruding section 86 explained below. The through hole 82 is provided to penetrate the unit holding section 60 in the width direction X.

The unit fixing section 61 includes a displacement section 83. The unit fixing section 61 may include a pair of displacement sections 83. The pair of displacement sections 83 is provided side by side in the width direction X. The pair of displacement sections 83 is provided on the outer side of the main body section 61A in the width direction X. The displacement section 83 is provided on the rear direction Y2 side of the main body section 61A.

The displacement section 83 is displaced when a pressing force is applied to the inner side of the unit fixing section 61 in the width direction X. That is, the displacement section 83 is displaced with respect to the width direction X intersecting the release direction R. The width direction X is equivalent to an example of a displacement direction.

The displacement section 83 includes a flexible section 84. The flexible section 84 bents in the width direction X when a pressing force is applied to the inner side of the unit fixing section 61 in the width direction X. The flexible section 84 has a V shape when viewed from the rear Y2 but is not limited to this.

The flexible section 84 includes a gripping section 85. The gripping section 85 is provided at the upper end portion of the flexible section 84. When the unit fixing section 61 is disposed at the fixing position P21, the gripping section 85 is located further in the upward direction Z1 than the main body section 61A. That is, even when the unit fixing section 61 is disposed at the fixing position P21, the gripping section 85 can be gripped by a user.

When the unit fixing section 61 is unlocked, the gripping section 85 can be gripped by the user when the displacement section 83 is displaced to the inner side in the width direction X of the unit fixing section 61. The gripping section 85 can be gripped by the user also when the unit fixing section 61 is moved between the fixing position P21 and the release position P22.

The flexible section 84 includes the protruding section 86. The protruding section 86 is provided to protrude to the outer side in the width direction X of the flexible section 84. The protruding section 86 fits in the through hole 82 when the unit fixing section 61 is disposed at the fixing position P21. The protruding section 86 has a shape having an inclined surface and an upper surface but is not limited to this. The inclined surface is provided to protrude further to the outer side in the width direction X toward the upward direction Z1.

Halfway in the unit fixing section 61 moving from the release position P22 to the fixing position P21, the inclined surface of the protruding section 86 comes into contact with the upper surface of the locked section 81. Accordingly, the flexible section 84 bends to the inner side in the width direction X.

When the unit fixing section 61 moves from the release position P22 to the fixing position P21, the protruding section 86 fits in the through hole 82. Accordingly, the flexible section 84 does not bend in the width direction X. Accordingly, the displacement section 83 restricts movement of the unit fixing section 61 from the fixing position P21 in the release direction R.

When the user presses the displacement section 83 to the inner side in the width direction X when the unit fixing section 61 is disposed at the fixing position P21, the flexible section 84 bends to the inner side in the width direction X. Accordingly, the protruding section 86 retracts from the through hole 82. In this case, the unit fixing section 61 is movable from the fixing position P21 to the release position P22. As explained above, the displacement section 83 allows, with the displacement in the width direction X, the unit fixing section 61 to move in the release direction R from the fixing position P21. The displacement section 83 is equivalent to an example of a restriction section.

### Action and Effects of the Second Embodiment

Action and effects of the second embodiment are explained.

(2-1) With this configuration, it is possible to allow, with the displacement of the displacement section 83 in the width direction X, the unit fixing section 61 to move in the release direction R from the fixing position P21. As explained above, it is possible to allow, with the displacement of the displacement section 83 in the width direction X intersecting the release direction R, the unit fixing section 61 to move in the release direction R from the fixing position P21. Accordingly, since the release direction R and the width direction X intersect, it is possible to prevent the user from unintentionally removing the cutter unit 40 from the cutter carriage 41. Therefore, safety for the cutter blade 50 can be improved.

### Modifications

The present embodiment can be changed and implemented as explained below. The present embodiment and the following modifications can be implemented in combination with each other as long as no technical inconsistencies are involved.

In the first embodiment, the first contact section 71 may have any shape such as a planar shape if the first contact section 71 can lock the unit fixing section 61 by coming into contact with the unit lock section 64. The second contact section 72 may have any shape such as a planar shape if the second contact section 72 can lock the unit fixing section 61 by coming into contact with the unit lock section 64. The recording device 10 may not include at least one of the first contact section 71 and the second contact section 72.

In the second embodiment, the locked section 81 may include a recess provided in the width direction X in the unit holding section 60 instead of the through hole 82. The recess may be provided on the inner side of the unit holding section 60 in the width direction X but is not limited to this.

In the second embodiment, the displacement section 83 may have another form such as a push latch if the displacement section 83 can be displaced in the displacement direction intersecting the release direction R. The displacement direction only has to intersect the release direction R and may be the front-rear direction Y.

The recording device 10 may include an opening and closing detection section that detects that the opening and closing cover 11B is closed. The control section 35 may execute steps S14 to S17 of the replacement control processing when the opening and closing detection section detects that the opening and closing cover 11B is closed. The control section 35 may execute steps S14 to S17 of the replacement control processing when the replacement completion instruction is input and the opening and closing cover 11B is closed.

When position information of the cutter carriage 41 deviates from an allowable range when the replacement completion command is input, the control section 35 may determine whether the predetermined error has occurred. The allowable range is a range of position information in which standard movement of the cutter carriage 41 is considered and is a: range in which it is determined that the predetermined error has not occurred. Not only when the replacement completion instruction is input, the control section 35 may determine whether the predetermined error has occurred.

The unit lock section 64 only has to be provided in at least one of the unit holding section 60 and the unit fixing section 61. That is, the unit lock section 64 may be provided in one of the unit holding section 60 and the unit fixing section 61 or may be provided to straddle both of the unit holding section 60 and the unit fixing section 61.

The unit fixing section 61 may linearly move with respect to the unit holding section 60. That is, the unit fixing section 61 only has to move with respect to the unit holding section 60.

The restriction section only has to include at least any one of the cover lock section 70, the restriction wall 11C, and the unit lock section 64. The recording device 10 may include both the first contact section 71 and the second contact section 72 in the first embodiment and the displacement section 83 in the second embodiment.

A lateral printer may be adopted as the recording device 10. The lateral printer is a printer in which the recording carriage 36 can move in two directions of a main scanning direction and a sub scanning direction.

The cutter unit 40 includes the cutter blade 50 for cutting the medium 90 but is not limited to this. For example, the cutter unit 40 may include a cutter blade for cutting the medium 90 to form a fold on the medium 90. As explained above, the cutter unit 40 only has be a unit having a cutter blade for cutting the medium 90 in the conveyance path 24. That is, the recording device 10 may include a cutting section.

The recording device 10 may be configured to record an image on at least one of the roll paper 91 and the paper 92 serving as the medium 90. The medium 90 may be of any type if the medium is cut by the cutter blade 50 in the recording device 10. The medium 90 may be paper, a film or a sheet made of resin, a composite film of resin and metal, a laminate film, a woven fabric, a nonwoven fabric, a metal foil, a metal film, a ceramic sheet, clothing, or the like.

The liquid can be optionally selected if the liquid can perform recording on the medium 90 by adhering to the medium 90. For example, the ink includes ink in which particles of a functional material composed of a solid matter such as a pigment or a metal particle are dissolved, dispersed, or mixed in a solvent and includes various compositions such as aqueous ink, oil-based ink, gel ink, and hot melt ink.

The recording device 10 is not limited to the inkjet printer and may be a dot impact printer. A recording scheme of the recording device 10 may be a laser scheme rather than the inkjet scheme.

The expression “at least one of” used in the present specification means one or more of desired choices. As an example, the expression “at least one of” used in the present specification means only one choice or both of two choices if the number of choices is two. As another example, the expression “at least one of” used in the present specification means only one choice or a combination of any two or more choices if the number of the choices is three or more.

### APPENDICES

Technical ideas grasped from the embodiments and the modifications explained above and action effects thereof are described below. The technical ideas and the action effects thereof can be combined with each other within a range in which there is no technical contradiction.

(A) A recording device including: a conveyance section configured to convey a medium in a conveyance direction along a conveyance path; a recording section configured to record an image on the medium conveyed by the conveyance section; a cutter unit including a cutter blade for cutting the medium in the conveyance path; a cutter carriage to which the cutter unit is detachably attachable, the cutter carriage moving in a width direction intersecting the conveyance direction; and a restriction section configured to restrict detachment of the cutter unit from the cutter carriage.

With this configuration, it is possible to restrict removal of the cutter unit including the cutter blade from the cutter carriage. Accordingly, it is possible to prevent a user from unintentionally removing the cutter unit from the cutter carriage. Therefore, safety for the cutter blade can be improved.

(B) The recording device may further include a housing, the housing may include an opening section and an opening and closing cover capable of opening and closing the opening section, the housing may house at least the cutter unit and the cutter carriage and enable operation of removing the cutter unit from the cutter carriage via the opening section, and the restriction section may include a cover lock section configured to lock the opening and closing cover in a state in which the opening section is closed.

With this configuration, since the opening and closing cover is locked in a state in which the opening section is closed, it is possible to restrict the operation of removing the cutter unit from the cutter carriage. Accordingly, it is possible to prevent a user from unintentionally removing the cutter unit from the cutter carriage. Therefore, safety for the cutter blade can be improved.

(C) In the recording device, the cover lock section may unlock the opening and closing cover according to an instruction from a user.

With this configuration, by unlocking the opening and closing cover as intended by the user, it is possible to enable the operation of removing the cutter unit from the cutter carriage. Accordingly, it is possible to prevent a user from unintentionally removing the cutter unit from the cutter carriage. Therefore, safety for the cutter blade can be improved.

(D) The recording device may further include a housing, the housing may include an opening section and an opening and closing cover capable of opening and closing the opening section, the housing may house at least the cutter unit and the cutter carriage and enable the operation of removing the cutter unit from the cutter carriage via the opening section, the cutter carriage may be movable between a standby position and an attachment and detachment position, and the restriction section may include a restriction wall that restricts the operation of removing the cutter unit from the cutter carriage via the opening section when the cutter carriage is disposed at the standby position in a state in which the opening section is opened.

With this configuration, it is possible to restrict, with the restriction wall, the operation of removing the cutter unit from the cutter carriage. Accordingly, it is possible to prevent a user from unintentionally removing the cutter unit from the cutter carriage. Therefore, safety for the cutter blade can be improved.

(E) In the recording device, the cutter carriage may move from the standby position to the attachment and detachment position according to an instruction from a user.

With this configuration, by moving the cutter carriage from the standby position to the attachment and detachment position as intended by the user, it is possible to enable the operation of removing the cutter unit from the cutter carriage. Accordingly, it is possible to prevent a user from unintentionally removing the cutter unit from the cutter carriage. Therefore, safety for the cutter blade can be improved.

(F) In the recording device, the cutter carriage may include a unit fixing section configured to fix the cutter unit when the cutter unit is attached, the unit fixing section may be movable between a fixing position for fixing the cutter unit and a release position for not fixing the cutter unit, and, when the cutter carriage moves from the attachment and detachment position toward the standby position in a state in which the unit fixing section is disposed at the release position, the restriction wall may restrict the movement of the cutter carriage to the standby position by coming into contact with the unit fixing section.

With to this configuration, it is possible to restrict the movement of the cutter carriage from the attachment and detachment position to the standby position in the state in which the unit fixing section is disposed at the release position. It is possible to make it easy for the user to recognize that the unit fixing section is not disposed at the fixing position. Accordingly, it is possible to prevent a user from unintentionally removing the cutter unit from the cutter carriage. Therefore, safety for the cutter blade can be improved.

(G) The recording device may further include a first contact section, the cutter carriage may include a unit fixing section that is movable between a fixing position for fixing the cutter unit in a state in which the cutter unit is attached and a release position for not fixing the cutter unit and a unit lock section that can lock the unit fixing section in a state in which the unit fixing section is disposed at the fixing position, the restriction section may include the unit lock section, and the first contact section may cause the unit lock section to lock the unit fixing section by coming into contact with the unit lock section.

With this configuration, the first contact section can lock the unit fixing section at the fixing position by coming into contact with the unit lock section. Accordingly, it is possible to prevent a user from unintentionally removing the cutter unit from the cutter carriage. Therefore, safety for the cutter blade can be improved.

(H) The recording device may further include a second contact section, the cutter carriage may include a unit fixing section that is movable between a fixing position for fixing the cutter unit in a state in which the cutter unit is attached and a release position for not fixing the cutter unit and a unit lock section that can lock the unit fixing section in a state in which the unit fixing section is disposed at the fixing position, the restriction section may include the unit lock section, and the second contact section may cause the unit lock section to unlock the unit fixing section by coming into contact with the unit lock section.

With this configuration, the second contact section can release the lock of the unit fixing section by coming into contact with the unit lock section. In such a case, it is possible to move the unit fixing section to the release position and enable the operation of removing the cutter unit from the cutter carriage. Accordingly, it is possible to prevent a user from unintentionally removing the cutter unit from the cutter carriage. Therefore, safety for the cutter blade can be improved.

(I) The recording device may further include a first contact section and a second contact section, the cutter carriage may include a unit fixing section that is movable between a fixing position for fixing the cutter unit in a state in which the cutter unit is attached and a release position for not fixing the cutter unit and a unit lock section that can lock the unit fixing section in a state in which the unit fixing section is disposed at the fixing position, the cutter carriage may be movable between a standby position and an attachment and detachment position, the restriction section may include the unit lock section, when the cutter carriage moves from the attachment and detachment position to the standby position, the first contact section may cause the unit lock section to lock the unit fixing section by coming into contact with the unit lock section, and, when the cutter carriage moves from the standby position to the attachment and detachment position, the second contact section may cause the unit lock section to unlock the unit fixing section by coming into contact with the unit lock section.

With this configuration, when the cutter carriage moves from the attachment and detachment position to the standby position, the first contact section can lock the unit fixing section by coming into contact with the unit lock section. When the cutter carriage moves from the standby position to the attachment and detachment position, the second contact section can unlock the unit fixing section by coming into contact with the unit lock section. Accordingly, it is possible to prevent the user from unintentionally remove the cutter unit from the cutter carriage and it is possible to switch the lock of the unit fixing section according to the movement of the cutter carriage. Therefore, safety for the cutter blade can be improved.

(J) In the recording device, the cutter carriage may include a unit fixing section that is movable between a fixing position for fixing the cutter unit in a state in which the cutter unit is attached and a release position for not fixing the cutter unit and a unit lock section that can lock the unit fixing section in a state in which the unit fixing section is disposed at the fixing position, the unit fixing section may be movable to the release position by moving from the fixing position in a release direction, the unit lock section may include a displacement section that is displaced in a displacement direction intersecting the release direction, and the displacement section may allow the unit fixing section to move from the fixing position in the release direction according to displacement in the displacement direction.

With this configuration, it is possible to allow the movement of the unit fixing section in the release direction from the fixing position according to the displacement of the displacement section in the displacement direction intersecting the release direction. Accordingly, since the release direction and the displacement direction intersect, it is possible to prevent the user from unintentionally removing the cutter unit from the cutter carriage. Therefore, safety for the cutter blade can be improved.

What is claimed is:

1. A recording device comprising:
a conveyance section configured to convey a medium in a conveyance direction along a conveyance path;
a recording section configured to record an image on the medium conveyed by the conveyance section;
a cutter unit including a cutter blade for cutting the medium in the conveyance path;
a cutter carriage to which the cutter unit is detachably attachable, the cutter carriage moving in a width direction intersecting the conveyance direction; and
a restriction section configured to restrict detachment of the cutter unit from the cutter carriage.

2. The recording device according to claim 1, further comprising a housing, wherein
the housing includes an opening section and an opening and closing cover capable of opening and closing the opening section,
the housing houses at least the cutter unit and the cutter carriage and enables operation of removing the cutter unit from the cutter carriage via the opening section, and
the restriction section includes a cover lock section configured to lock the opening and closing cover in a state in which the opening section is closed.

3. The recording device according to claim 2, wherein the cover lock section unlocks the opening and closing cover according to an instruction from a user.

4. The recording device according to claim 1, further comprising a housing, wherein
the housing includes an opening section and an opening and closing cover capable of opening and closing the opening section,
the housing houses at least the cutter unit and the cutter carriage and enables the operation of removing the cutter unit from the cutter carriage via the opening section,
the cutter carriage is movable between a standby position and an attachment and detachment position, and
the restriction section includes a restriction wall that restricts the operation of removing the cutter unit from the cutter carriage via the opening section when the cutter carriage is disposed at the standby position in a state in which the opening section is opened.

5. The recording device according to claim 4, wherein the cutter carriage moves from the standby position to the attachment and detachment position according to an instruction from a user.

6. The recording device according to claim 4, wherein
the cutter carriage includes a unit fixing section configured to fix the cutter unit when the cutter unit is attached,
the unit fixing section is movable between a fixing position for fixing the cutter unit and a release position for not fixing the cutter unit, and
when the cutter carriage moves from the attachment and detachment position toward the standby position in a state in which the unit fixing section is disposed at the release position, the restriction wall restricts the movement of the cutter carriage to the standby position by coming into contact with the unit fixing section.

7. The recording device according to claim 1, further comprising a first contact section, wherein
the cutter carriage includes:
a unit fixing section that is movable between a fixing position for fixing the cutter unit in a state in which the cutter unit is attached and a release position for not fixing the cutter unit; and
a unit lock section that can lock the unit fixing section in a state in which the unit fixing section is disposed at the fixing position,
the restriction section includes the unit lock section, and
the first contact section causes the unit lock section to lock the unit fixing section by coming into contact with the unit lock section.

8. The recording device according to claim 1, further comprising a second contact section, wherein
the cutter carriage includes:
a unit fixing section that is movable between a fixing position for fixing the cutter unit in a state in which the cutter unit is attached and a release position for not fixing the cutter unit; and
a unit lock section that can lock the unit fixing section in a state in which the unit fixing section is disposed at the fixing position,
the restriction section includes the unit lock section, and
the second contact section causes the unit lock section to unlock the unit fixing section by coming into contact with the unit lock section.

9. The recording device according to claim 1, further comprising:
a first contact section; and
a second contact section, wherein
the cutter carriage includes:
a unit fixing section that is movable between a fixing position for fixing the cutter unit in a state in which the cutter unit is attached and a release position for not fixing the cutter unit; and
a unit lock section that can lock the unit fixing section in a state in which the unit fixing section is disposed at the fixing position,
the cutter carriage is movable between a standby position and an attachment and detachment position,
the restriction section includes the unit lock section,
when the cutter carriage moves from the attachment and detachment position to the standby position, the first contact section causes the unit lock section to lock the unit fixing section by coming into contact with the unit lock section, and
when the cutter carriage moves from the standby position to the attachment and detachment position, the second contact section causes the unit lock section to unlock the unit fixing section by coming into contact with the unit lock section.

10. The recording device according to claim 1, wherein
the cutter carriage includes:
a unit fixing section that is movable between a fixing position for fixing the cutter unit in a state in which the cutter unit is attached and a release position for not fixing the cutter unit; and
a unit lock section that can lock the unit fixing section in a state in which the unit fixing section is disposed at the fixing position,
the unit fixing section is movable to the release position by moving from the fixing position in a release direction,
the unit lock section includes a displacement section that is displaced in a displacement direction intersecting the release direction, and
the displacement section allows the unit fixing section to move from the fixing position in the release direction according to displacement in the displacement direction.
